(19) United States
(12) Patent Application Publication
(10) Pub. No.: US 2003/0087046 A1
(43) Pub. Date: May 8, 2003

(54) Artificial rock and method for forming an artificial rock

(75) Inventor: Randall M. Carpenter, Canyon Country, CA (US)

Correspondence Address: LYON & LYON LLP, 633 WEST FIFTH STREET, SUITE 4700, LOS ANGELES, CA, 90071, US

(73) Assignee: Design Rockatecture, Inc.

(21) Appl. No.: 10/053,280

(22) Filed: Nov. 8, 2001

(51) Int. Cl. A01N 1/00; B29C 35/02; B32B 1/02

(52) U.S. Cl. 428/15; 425/409; 264/40.1; 428/34.4

(57) ABSTRACT

A method for forming artificial rocks that possess suitable weight and strength and that allows for the formation of artificial rocks with large undercuts is provided. The method consists of creating an outer mold of a natural rock, then using the mold to create a test artificial rock. The test rock is then structurally tested. Structural reinforcement members are added to the interior of a second test rock to structurally strengthen the test rock until a suitable test rock is created. The suitable test rock is then used to create an inner shell conforming to the inside surface of the test rock. Production rocks are created by molding a cementitious material between the outer mold and the inner shell. Additionally, a stand suitable for holding the artificial rock in a stable position during manufacture and that allows for the easy release of an artificial rock after formation is provided.

### FIELD OF INVENTION

This invention relates generally to artificial rocks and processes for forming artificial rocks.

### BACKGROUND OF THE INVENTION

Artificial rocks are valuable replacements for natural rocks in landscaping. Natural rocks are heavy, bulky, and difficult to transport, expensive, and normally located great distances from the area to be landscaped. The use of natural rocks in landscaping also requires extensive excavation of the ground at the time of installation and during any change in the landscaping.

Artificial rocks solve many of the problems associated with the use of natural rocks. Artificial rocks are lighter, less bulky, easier to transport, and less expensive than using natural rocks in landscaping. Further, using artificial rocks requires less excavation at the time of installation and during landscaping changes. The use of artificial rocks also allows a landscaper to simulate landscapes that are naturally found in areas far from the location of the landscape.

While there are many advantages of using artificial rocks, prior to this invention there were many drawbacks. Existing methods of forming artificial rocks are not designed to allow the replication of natural rocks with surface features such as deep undercuts. This limited the possible designs of artificial rocks.

Existing methods also do not allow the formation of artificial rocks optimized for weight and strength. A common technique for forming artificial rocks prior to this invention was to form the artificial rock with a uniform wall thickness. However, an artificial rock with uniform walls typically has portions where the walls are too thick, making the artificial rock overweight, and areas of the rock where the walls are too thin, making the artificial rock unable to withstand expected loads resulting in cracking. Accordingly, a need exists for artificial rocks that are better optimized for both weight and strength. A need also exists for a method of forming such artificial rocks.

### SUMMARY OF THE INVENTION

In accordance with a first aspect of the invention, a method for manufacturing an artificial rock is provided. The method includes an initial step of making an outer negative mold of a surface of a natural rock. A test artificial rock is then formed using the outer negative mold. The test artificial rock comprises an outer surface that replicates the portion of the surface of the natural rock and an inner surface defining a cavity. Reinforcing members are added to the inner surface of the test artificial rock to strengthen the test artificial rock in desired locations. An inner mold is then made of the inner surface of the test artificial rock. The artificial rock may then be formed from a liquid cementitious material by molding the liquid cementitious material between the outer mold and inner mold.

In a preferred embodiment, the outer mold comprises a malleable mold and a semi-rigid outer shell. The malleable mold comprises an inner surface having a negative impression of the portion of the surface of the natural rock being replicated and a comparatively smooth outer surface. The semi-rigid outer shell comprises an inner surface that forms a cavity that is complementary to the outer surface of the malleable mold.

By using a two-part outer mold of the foregoing construction, artificial rocks having deeper fissures or undercuts than could previously be replicated can now be relatively easily molded.

In another aspect of the invention an artificial rock with an improved strength to weight ratio is provided. The artificial rock comprises a dome of hardened cementitious material having a generally concave interior surface and an exterior surface that replicates surface features of a natural rock. The artificial rock further comprises reinforcing ribs along the interior surface of the dome. The artificial rock may further comprise a reinforcing ring around the edge of the inner circumference of the dome.

In yet another aspect of the invention, a stand is provided to support the outer mold during the artificial rock molding process. The stand design is customized for each artificial rock design. The stand design allows the outer and inner molds to be securely held during the artificial rock fabrication process, yet the stand design also includes a rocker arm that permits the stand to be easily rotated to discharge the completed artificial rock from the outer mold.

Further objects, features and advantages of the invention will be better understood from the following description considered in connection with the accompanying drawings.

### BRIEF DESCRIPTION OF THE DRAWINGS

Preferred embodiments of the present invention are illustrated by way of example, and not by way of limitation, in the figures of the accompanying drawings, in which like reference numerals refer to like components, and in which:

FIG. 1 shows a side cut-view of a natural rock found in the environment that has been placed in a setting bed;

FIG. 2 shows a side cut-view of the same natural rock as shown in FIG. 1 with a molding material coated on all of the exposed surfaces of the natural rock;

FIG. 3 shows a side cut-view through a completed outer mold according to one embodiment of the present invention formed over the same natural rock as shown in FIGS. 1 and 2;

FIG. 4 shows a side cut-view of the outer mold shown in FIG. 3 inverted from its position on the natural rock and placed on a support stand and having a cementitious material spread on the inner wall of the outer mold to form a test artificial rock;

FIG. 5 shows a side view of a set-up that may be used for making cementitious material that may be used in forming test artificial rocks in accordance with one embodiment of the method according to the present invention;

FIG. 6 shows a side cut-view through an artificial rock inverted in the outer mold, the same view as in FIG. 4, with reinforcing members made from a cementitious material arranged on the inner wall of the artificial rock;

FIG. 7 shows a portion of the inside surface of an artificial rock according to the present invention in perspective view and illustrates a typical rib pattern that may be employed on the interior surface of an artificial rocks according to the present invention to strengthen them;

FIG. 8 shows a side cut-view through the artificial rock with reinforcing ribs as shown in FIG. 7 further with an inner mold positioned on the inside surface of the artificial rock;

FIG. 9 shows a side cut-view of the inner mold hinged to the outer mold on one side, where the inner mold is rotated up and away from the inverted outer mold and water has been added to the cavity formed by the inverted outer mold;

FIG. 10 shows a side cut-view of the inner mold hinged to the outer mold on one side, where the inner mold is rotated to a closed position with respect to the outer mold and the water shown in FIG. 9 has been displaced within the cavity formed by the inverted outer mold and inner mold;

FIG. 11 shows a side cut-view of the inner mold hinged to the outer mold on one side, where the inner mold is rotated up and-away from the inverted outer mold and liquid cementitious material has been added to the cavity formed by the inverted outer mold;

FIG. 12 shows a side cut-view of the inner mold hinged and rotated to a near closed position with respect to the outer mold, and where the liquid cementitious material shown in FIG. 11 is shown as being partially displaced in the space formed between the outer mold and the inner mold; and

FIG. 13 shows a side cut view of a set of artificial rocks of the same design stacked and ready for transportation;

### DETAILED DESCRIPTION OF THE PREFERRED EMBODIMENTS

In accordance with the invention, an improved artificial rock, a process for forming an improved artificial rock and a stand for fabricating an artificial rock are provided. The artificial rocks according to the present invention may be used in landscaping and in other environments where the use of natural-looking rocks may be desired, but the use of actual rocks is impracticable or undesirable. For example, it is often preferable to use artificial rocks over natural rocks because it may be difficult to locate suitable natural rocks near the landscaping or other environment. In addition, it is difficult and expensive to transport natural rocks and it is difficult, time consuming, and expensive to modify a landscape that uses natural rocks. Furthermore, the weight of natural rocks simply makes their use impracticable in certain applications.

The artificial rocks according to the present invention are preferably structurally optimized for weight and strength so that no section of an artificial rock is too weak to withstand anticipated loads, yet the artificial rock remains as light as possible. This may be accomplished with the artificial rocks according to the present invention by adding reinforcing members or ribs at desired locations to the inner surface of the artificial rocks. In this manner, the artificial rocks according to the present invention may be made as light as possible while still exhibiting adequate structural strength in those areas of the artificial rocks that include undercuts or other transition areas that act as stress concentrators.

Preferred embodiments depicting various aspects of the invention will now be described.

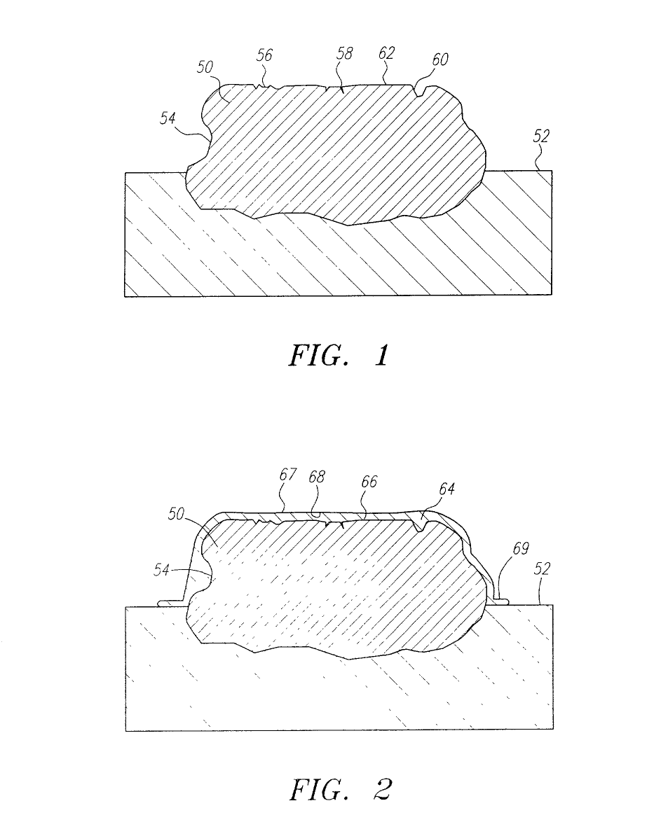

FIG. 1 shows a side cut-view of a natural rock 50 placed in a setting bed 52. A natural rock 50 found in the environment resides with a portion of the natural rock below the surface of the ground. Therefore, an artificial rock need only replicate a portion of the natural rock. The portion of the natural rock that is replicated can be the portion of the natural rock that was exposed in the environment or another portion of the rock may be selected for duplication as the artificial rock.

In addition to the cost and weight savings, there are other advantages in replicating only a portion of a natural rock. An artificial rock that only replicates a portion of the natural rock will not require an extensive excavation under the artificial rock prior to the placement of the artificial rock to achieve a natural look. The placement of an artificial rock made in this manner only requires a minor excavation of the ground under the artificial rock, just enough so that the edges of the artificial rock are not easily observed. Such an artificial rock also allows for an easy change in the placement of the artificial rock as compared to a natural rock, because less excavation is required in the new location and little ground repair is required under the old location.

As shown in FIG. 1, a natural rock 50 typically does not have a relatively smooth surface. The surface of a natural rock can include, for example, natural undercuts 54 and other surface features such as surface pits 56, surface cracks 58, and surface indentations 60. A realistic alternative for a natural rock needs to accurately duplicate these natural features.

After a suitable natural rock 50 in the environment is identified, the natural rock 50 is moved from that location and placed in a setting bed 52 of either sand or concrete, as shown in FIG. 1. As reviewed above, it is not necessary, nor even preferred, to place the natural rock 50 in the setting bed 52 so that the same portion of the natural rock 50 that was exposed above the ground in the rock's natural environment is exposed above the setting bed 52. Often, a different orientation or depth of placement of the natural rock into the setting bed can be used to develop a more pleasing artificial rock.

A more desirable artificial rock is formed if the following factors are considered when placing the artificial rock in the setting bed. First, the natural rock 50 is placed in the setting bed 52 so that an attractive section of the natural rock 50 is exposed above the setting bed. Second, the natural rock is placed in the setting bed so that the portion of the natural rock that is exposed above the setting bed can be replicated in an outer mold according to the present invention. Thus, if the natural rock contains too deep of fissures or excessive undercuts, those sections of the natural rock are preferably placed such that they are hidden in the setting bed and not exposed.

Finally, the natural rock 50 is preferably set into the setting bed 52 to a depth that allows the later formed artificial rock to be suitable for stacking during transportation with other artificial rocks that are molded to replicate the same natural rock. This is achieved by setting the natural rock 50 in the setting bed 52 such that the shape of the perimeter of the natural rock at the interface of the natural rock and setting bed is larger than the shape of the natural rock furthest from the setting bed. Since only the portion of the natural rock 50 residing above the setting bed 52 is duplicated, this placement allows for an opening on the bottom of the artificial rock that is larger than the top of the artificial rock. This in turn allows duplicate artificial rocks to be stacked such that an artificial rock on the bottom of the stack can rest slightly inside of the artificial rock just above. This also allows a greater number of artificial rocks to be placed on one stack, increasing the number of artificial rocks that can be transported in the same shipment.

In addition to sand and concrete, other materials are envisioned for the setting bed 52. The setting bed 52 can be formed either near the location where the natural rock 50 was located or at a distant location if the natural rock 50 is suitable for transporting.

After the natural rock 50 is placed in the setting bed 52, the exposed surfaces of the natural rock 50 are cleaned to remove all dirt, moss, and loose particles. After the exposed surfaces of the natural rock 50 are cleaned, a release agent 62 is then applied to all exposed surfaces of the natural rock. A common and commercially available release agent such as “seal lube,” sold by AR Products, is typically used as a release agent although any other type of release agent could also be used.

After the release agent 62 dries, a malleable mold 64, as shown in FIG. 2, is formed over the exposed surfaces of natural rock 50, and over the release agent 62. Malleable mold 64 comprises a malleable molding material, such as a latex rubber material. The malleable mold 64 may be formed by applying layers of the malleable molding material over the exposed surface of natural rock 50 until a comparatively smooth outer surface 68 is formed. The malleable molding material is also preferably applied to provide malleable mold 64 with a molding lip 69 on top of the setting bed 52 and around the entire circumference of the natural rock 50.

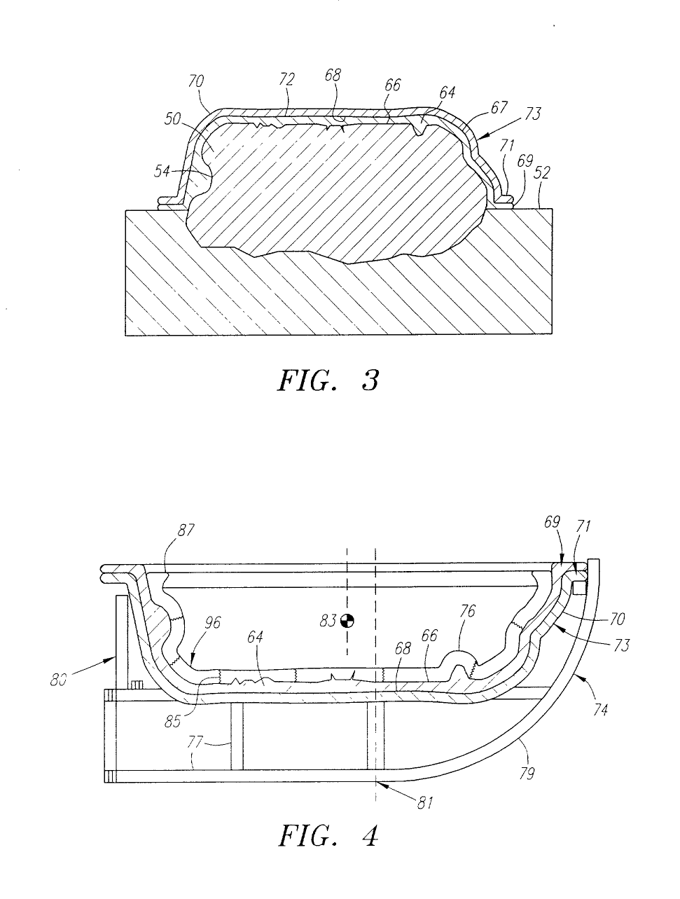

The malleable mold 64 should completely fill in areas of the natural rock that contain large cavities or concave areas, such as undercut 54. As best seen in FIG. 3, the malleable mold 64 needs to fill in concave areas so that a semi-rigid outer shell 70 that is used to support the malleable mold 64, and that is formed around malleable mold 64, may be easily removed from the natural rock 50. If the malleable mold 64 does not fill in large cavities or concave areas, the semi-rigid outer shell 70 may protrude too far into a cavity or concave undercut of the rock to permit its removal from the rock 50 without damage to itself or malleable mold 64. If semi-rigid outer shell 70 may be easily removed from rock 50, it will also typically be easily removed from artificial rocks that are subsequently molded using outer shell 70 and malleable mold 64. Thus, the malleable mold 64 should fill in the entire concave undercut 54 and generally have a smooth outer surface 68 for mating with the semi-rigid outer shell 70 to prevent removal problems.

A negative impression is made in the inner surface 66 of the malleable mold 64 of the exposed surface of the natural rock 50 including the inside of the surface cracks 58 and surface pits 56 of the natural rock 50. A negative impression of the details of those surface imperfections remains in the inner surface 66 of the malleable mold 64 when the malleable mold 64 is later removed from the natural rock 50.

After the malleable mold 64 has sufficiently hardened, an outer release agent 67 is applied over the entire exterior surface 68 of the malleable mold 64. A common and commercially available release agent such as “Part-All” is used as the outer release agent 67, however, any other release agent could also be used.

Referring again to FIG. 3, after the outer release agent 67 is applied over the malleable mold 64, the semi-rigid outer shell 70 is formed over the entire outer surface of the malleable mold 64. Semi-rigid outer shell 70 preferably comprises fiberglass or other suitable semi-rigid material. Thus, for example, semi-rigid outer shell 70 may be formed by applying fiberglass over the outer surface 68 of the malleable mold 64. The outer shell 70 is preferably formed with a flange lip 71 around the entire outer shell 70. Flange lip 71 is formed over the molding lip 69, where the outer shell 70 adjoins the setting bed 52.

After the outer shell 70 has hardened sufficiently to allow removal, the outer shell 70 and the malleable mold 64 are removed from the natural rock 50. The malleable mold 64 and the outer shell 70 form a unique matched set and collectively comprise an outer mold 73. The malleable mold 64 has a negative impression of all of the surface details of the natural rock 50 formed into its inner surface 66, the surface formed against the natural rock 50. On the other hand, the outer surface 68, the surface of the malleable mold 64 formed away from the surface of the natural rock 50, mates with a complementary inner surface 72 of the outer shell 70. The outer shell 70 and the malleable mold 64 may be removed from the location where the natural rock 50 was found and there is no further need for the natural rock 50.

Referring now to FIG. 4, the outer mold 73, comprising the malleable mold 64 and the outer shell 70, is inverted and placed upon support stand 74. In a preferred embodiment of the method for forming an artificial rock according to the present invention, support stand 74 is vibrated during the artificial rock formation process. Accordingly, support stand 74 is preferably designed to hold weight substantially in excess of the artificial rock to be formed, as the support stand 74 will have to withstand forces in excess of the artificial rock due to the increased forces from vibration during the formation process.

Each support stand 74 is designed to uniquely match the strength, stiffness, and balance requirements of a specific artificial rock design. Thus, a unique support stand is designed for each outer mold 73 that will be used to produce a unique artificial rock design.

Support stand 74 is formed from mostly straight members 77. Straight members 77 are preferably made of metal, and more preferably weldable grades of steel or aluminum. Straight members 77 may be connected horizontally and vertically to form a frame 80 to support the outer mold 73 at various points along the length and width of the outer mold 73. Support stand 74 also includes a rocker arm 79. Rocker arm 79 may, for example, be manufactured from curved sections of metal, preferably weldable grades of steel or aluminum. Accordingly, the straight members 77 and rocker arm 79 are preferably welded together. While it has been found that metal tubes work well for the straight members 77 forming frame 80 and the rocker arm 79 and support stand 74 generally, other materials could also be used.

Support stand 74 also includes a rocker pivot 81 at the point where rocker arm 79 joins straight section 77. Support stand 74 is designed such that rocker pivot 81 is positioned between the outer mold center of gravity 83 and rocker arm 79 when the support stand is in its upright position, as shown in FIG. 4. However, support stand 74 is further designed so that when the support stand 74 is tipped slightly on its rocker arm 79 the outer mold center of gravity 83 crosses the rocker pivot 81. This design allows support stand 74 to be stable during the formation of an artificial rock but allows the support stand 74 to be quickly and easily rotated and inverted, for easy dislodgment of a completed artificial rock.

In view of the foregoing teachings it will be appreciated that support stand 74 is designed so that a majority of the volume of the inverted mold is situated over the straight sections 77 forming frame 80 and a minority of the volume of the inverted mold is situated over the rocker arm 79. This placement of the outer mold center of gravity 83 over the straight sections 77, but near the pivot initiation line 81 of the support stand 74 allows the support stand 74 to be stable during the formation of an artificial rock. At the same time, however, such a placement allows the easy tipping of the support stand 74 to dislodge a formed artificial rock from the mold. Practice of the invention has shown that situating approximately 60% of the volume of the mold over the straight sections 77 forming frame 80 and situating approximately 40% of the volume of the inverted mold over the rocker arm 79 provides adequate stability while still allowing the support stand 74 to be easily tipped for removal of a molded artificial rock.

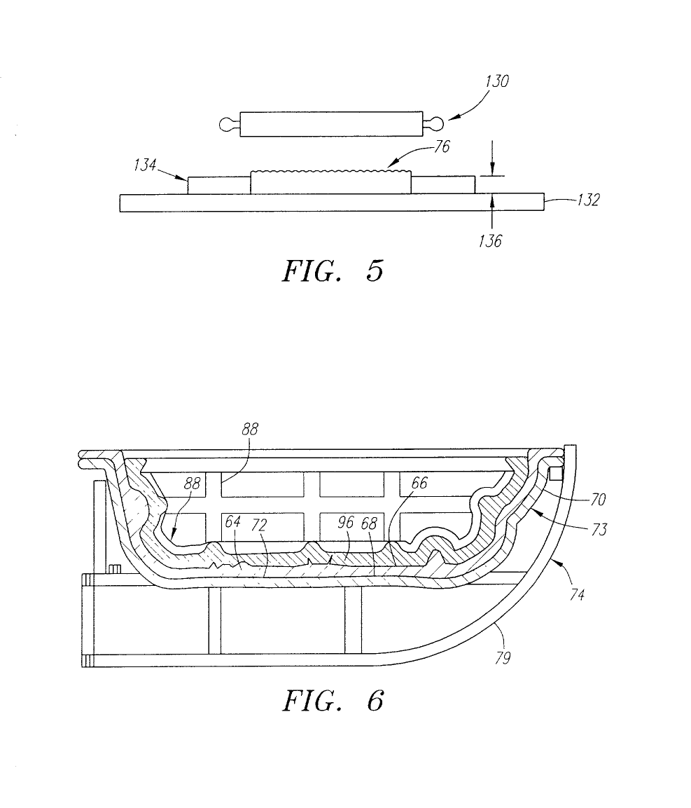

After the outer mold 73 is placed in the support stand 74, a cementitious material 76 for forming an artificial rock is formed. As shown in FIG. 5, the artificial rock cementitious material 76 may be formed by hand troweling cementitious material 76 in a dry pack state onto set up board 132 between two flat thickness guides 134.

The two thickness guides 134 are of the same height and length and are fastened to the setup board 132 on separate parallel lines such that they are not spaced farther apart than the rolling area of rolling pin 130. The height of the thickness guides, shown as item 136 in FIG. 5, are sized according to the overall size of the artificial rock to be formed. Generally, smaller artificial rocks can be made with a thinner minimum thickness of cementitious material than larger artificial rocks. Experience has shown that adding fiber reinforcement to the cementitious material 76 makes it easier to handle and can provide strength to the finished product. A wide variety of fibrous materials are suitable for use in the manufacture of an artificial rock according to the present invention.

After the cementitious material 76 is hand troweled in a dry pack state onto the setup board 132 between the two flat thickness guides 134, the cementitious material 76 is then rolled by roller pin 130 to a uniform thickness. A knife or other sharp object is used to trim the ends of the cementitious material to create a rectangular shape. The use of the setup board 132 to create rectangular pieces of the cementitious material 76 allows the easy manufacture of uniform thickness cementitious material 76 that can be used to form an artificial rock of uniform thickness.

The cementitious material 76, which is now rectangular shaped, can be removed from the setup board 132 by hand and placed in the inside of outer mold 73. FIG. 4 shows the outer mold 73 with rectangular strips of the cementitious material 76 added to form an artificial rock 96. The cementitious material is added to the outer mold 73 in a quilting fashion. The edges of the rectangular sections of cementitious material, or quilt lines, are shown as item 85 in FIG. 4.

Extra strips of cementitious material 76 are preferably placed all along the inner circumferential portion of the outer mold 73. These extra strips of cementitious material 76 form a reinforcement ring 87 that provides hoop strength to the inner circumference of the artificial rock 96. The extra strips of cementitious material 76 can be used to increase the thickness of the lip greatly. Experience has shown that doubling or even tripling the thickness of the edges can be desirable. This reinforcement is an important feature that allows the artificial rocks, which are weaker than a natural rock since the artificial rocks are hollow and are not a complete sphere shape, to resist breakage from the application of pressure and also allows the artificial rocks to be transported without damage.

One of the considerations in determining the proper thickness of the cementitious material 76 in a given region of the artificial rock 96 is the local geometric features. For instance, local surface imperfections such as surface cracks 58 or surface pits 56 create stress concentrations in the artificial rock 96. The wall thickness of the regions of an artificial rock 96 that include these features is preferably thicker than the wall thickness of the regions of the artificial rock 96 without these features to counteract these stress concentrations. This will allow the structural strength of the artificial rock 96 to be similar in regions with stress concentrations as in regions without stress concentrations.

A second consideration in determining the proper thickness of the cementitious material 76 in a given region of the artificial rock 96 is the curvature of the artificial rock 96 in that region. Wall curvature adds strength and double wall curvature—curvature in both horizontal and vertical directions—adds even more strength. Thus, regions of the artificial rock 96 where the walls are curved can be thinner than regions of the artificial rock 96 where the walls do not have curvature. Furthermore, regions where the artificial rock 96 has large flat sections must be substantially thicker than regions where the artificial rock has curvature.

Finally, when designing the wall thickness of an artificial rock 96, a minimum wall thickness has to be considered to account for local stability. Thus, the walls of an artificial rock 96 should be maintained at least at a minimum thickness, with the minimum thickness determined by the material used to create the artificial rock, even if the region of the artificial rock 96 is in a very low stress area.

To account for the above-listed variations, extra layers of cementitious material 76 can be added in desired regions during the formation of the artificial rock 96. In addition, layers of cementitious material of differing thickness can be used to build the wall thickness of the artificial rock 96 in different regions to any desired thickness.

The rectangular shaped pieces of the cementitious material 76 form a quilted effect inside of the outer mold 73 when the entire inner surface of the outer mold is covered with cementitious material 76. To complete an artificial rock 96, the quilt lines 85 are seamed up with loose cementitious material by hand troweling some of the same cementitious material that was used to form the uniform thickness rectangular sections.

After the cementitious material completely cures, the first artificial rock 96 is removed from the outer mold 73 by rotating the support stand 74 onto rocker arms 79 and rolling the support stand completely upside down, 180 degrees from its original position, in the plane of FIG. 4. The support stand is then rotated back to its original position, without the artificial rock, thereby dislodging the artificial rock from the support stand 74.

This first artificial rock 96, or “Adam” rock, is used to test the strength of the artificial rock design. This first artificial rock 96 is only a test artificial rock and is not as strong as a production artificial rock 99 because it has not been vibrated during the molding process, as will be explained later, and because its structural design has not been fully optimized. This first test artificial rock 96 tests the ability of the artificial rock to be removed from the outer mold 73 as there may have to be some slight stretching of the outer shell 70 and malleable mold 64 to accomplish removal of the artificial rock without destroying either. The amount of stretching of the outer shell 70 and malleable mold 64 depends upon the size and locations of any undercuts or other features on the original rock. Once the test artificial rock 96 is removed from the outer shell 70 and malleable mold 64, it is inspected for wall thickness and, generally, for quality.

The Adam rock is also tested for strength by various methods including compression testing. In one test, the Adam rock can be placed under uniform compression until cracking occurs. Lines perpendicular to the fissure planes identify the location and direction of the highest stresses in the artificial rock design. These high stress locations are areas suitable for the placement of stiffening ribs or members by the placement of extra cementitious material during the formation of the artificial rock design.

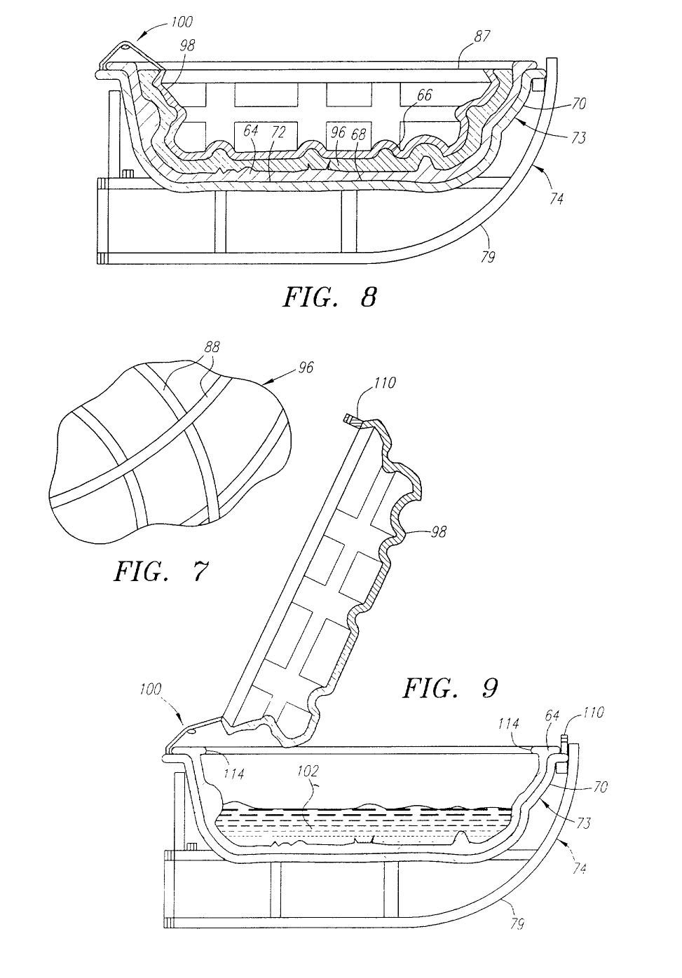

After fissure planes are identified, reinforcing ribs 88 are added to another test artificial rock 96 as shown in FIG. 6. The reinforcing ribs 88 comprise cementitious material 76 added using hand tools to strengthen and stabilize the artificial rock. The reinforcing ribs 88 can be made from cementitious material rolled out in a uniform thickness and then blended to the second test artificial rock with hand tools. Alternatively, the height of reinforcing ribs 88 can be varied to provide more strength in localized areas. FIG. 7 is a partial perspective view of the inside surface of a formed artificial rock 96 and shows a typical rib pattern formed by the placement of a plurality of reinforcing ribs 88.

After the second test artificial rock 96 is fully cured, it is removed from outer mold 73 as described above and tested for strength to determine if additional reinforcing members are required or whether the wall thickness of the artificial rock should be increased in any areas. If the second test artificial rock 96 does not possess suitable strength and weight, it can be re-made, re-inspected, and re-tested as described above until it is determined that the design does possess suitable strength and weight, and is preferably optimized in terms of these attributes for the cementitious material 76 being used. It is important for a proper test artificial rock 96 to be formed because all production artificial rocks 99 will be of the same design. Further, structurally inadequate regions, or, conversely, overweight areas, can be easily corrected during the test run phase, thus simplifying the production runs of the artificial rock design 99 discussed more fully below.

Once it is determined that the design of the test artificial rock 96 has sufficient strength, and the proper minimum wall thickness without excessively thick walls such that the production artificial rocks will be overweight, a semi-rigid inner shell 98, shown in FIG. 8, may be formed. The inner shell 98 may be formed in the same manner as the outer shell 70. First the inner surface of the test artificial rock 96 is sprayed with a release agent, such as Part-All, and then, after the release agent dries, a semi-rigid material, such as fiberglass is layered over the entire inner surface of the artificial rock 96. After the fiberglass inner shell 98 dries it is removed from the test artificial rock 96.

After the semi-rigid inner shell 98 is formed the test artificial rock 96 is no longer needed and can be discarded.

It is important that the semi-rigid inner shell 98, similar to the outer shell 70, be rigid enough to support the molding of artificial rocks but not so rigid it cannot deflect slightly when removing a molded artificial rock. Thus, molds comprising an outer shell 70 and inner shell 98 that are made from a deflectable but resilient material, such as fiberglass, and that have relatively thin walls, such that the inner and outer shells can deflect slightly to allow the removal of the molded artificial rocks, are preferred. By using outer and inner shells 70, 98 more types of rocks, with various surface features, such as undercuts that are found naturally in the environment, can be molded. In contrast, solid inner molds or bulky inner molds do not allow sufficient flexibility to mold artificial rocks with many of the natural features found on rocks in the environment, and, for this reason, are less desirable.

FIG. 8 shows a completed artificial rock mold comprising the outer mold 73 and the inner shell or mold 98. In this figure, the outer shell 70 is shown attached to the inner shell 98 by a hinge 100 on one side. The inner shell 98 can also be attached to the outer shell 70 by other methods including pins, rails or wires. While attaching the inner shell 98 to the outer shell 70 is not necessary, attaching the inner shell 98 to the outer shell 70 functions to keep proper alignment between the inner and outer shells 98, 70 during the fabrication process. In addition, it helps to keep the inner and outer shells 98, 70 together so that they are not inadvertently later used with a different mold assembly. This would be possible if, for instance, there was another mold that was a similar size and shape.

The following steps are related to forming a production artificial rock 99. First, the inner shell 98 is rotated up and away from the outer shell 70 allowing free access to the cavity inside the outer mold 73. The outer mold 73 is then filled partially with water 102 in an amount well in excess of the expected amount of cementitious material 76 that is required to form an artificial rock in this mold. This is shown in FIG. 9.

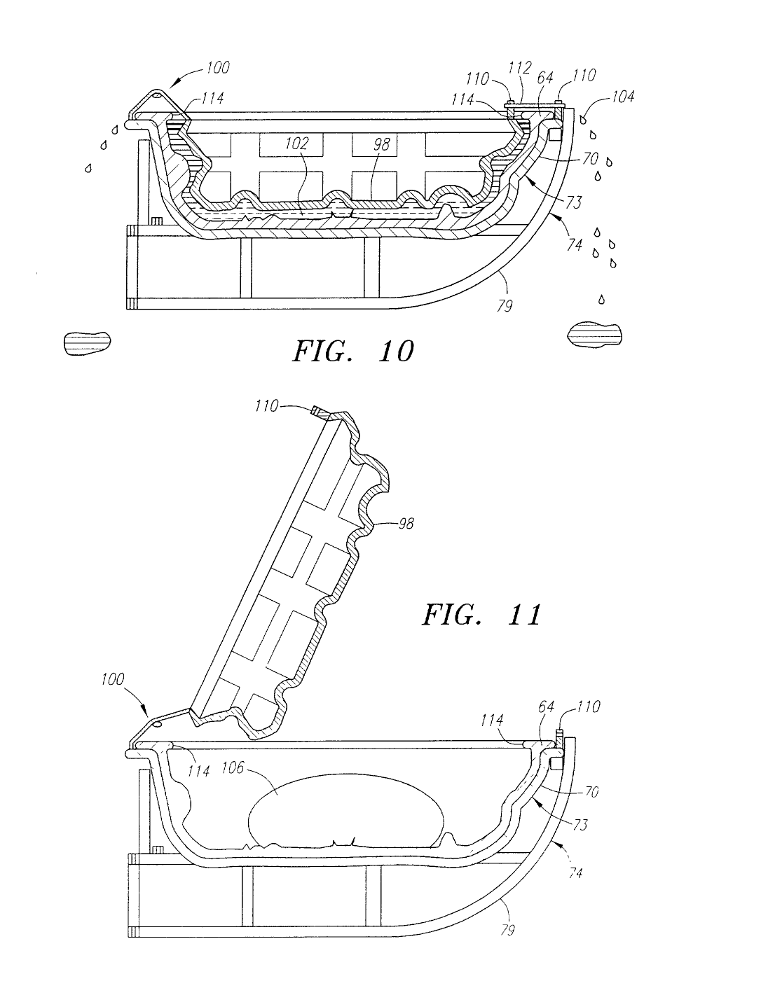

The inner shell 98 is then rotated down into the outer mold 73 until it reaches its final molding position. The inner shell 98 and the outer mold 73 preferably contain a latching mechanism 110 with a pin 112 that is placed through each latching mechanism 110, such that the inner shell 98 is maintained in a position above the outer mold 73 a sufficient distance, as shown in FIG. 10. However, any mechanism can be used, such that the inner shell 98 will be kept above the outer mold 73 a sufficient distance. The separation between the inner shell 98 and outer mold 73 is also accomplished by the hinge 100, which prevents the inner shell 98 from rotating to a point that it will come into contact with the outer mold 73.

As the inner shell 98 is rotated down into the outer mold, this process will spill excess water 104 from the cavity between the inner shell 98 and outer mold 73, as shown in FIG. 10. After the inner shell 98 has been completely rotated into position inside the outer mold 73, the inner shell 98 is then rotated back out of the outer mold 73 and the water remaining in the outer mold is poured into a measuring device, which is not shown.

The volume of the water remaining in the outer mold 73 after this step is a close approximation as to the volume of cementitious material 76 that is required to create a production artificial rock 99 in the mold. The volume of the cementitious material 76 used in the mold is greater than the volume of the water remaining in the mold. This extra cementitious material 76 accounts for the settling and compression of the cementitious material 76 during the formation of an artificial rock 99. Experience has shown that the volume of the cementitious material 76 that should be added to the outer mold 73 is approximately 2% greater than the volume of the water remaining in the mold. Settling of the cementitious material is preferably encouraged by attaching a standard vibrating motor, such as standard pneumatic vibrator, to the support stand 74 during the formation of the artificial rock 99. The settling and compression of the cementitious material 76 densifies the cementitious material 76 resulting in a stronger artificial rock.

To mold a production artificial rock 99, as shown in FIG. 11, the inner shell 98 and the malleable mold 64 are coated with a release agent prior to pouring a liquid artificial rock material 106 into the outer mold 73. The inner shell 98 is rotated up and away from the outer shell 70 and the liquid artificial rock material 106 is added to the outer mold 73. The liquid artificial rock material 106 comprises a cementitious material 76. However, it may be a different material from the cementitious material 76 described earlier that was used in the formation of the test artificial rock 96. While the liquid artificial rock material 106 is a cementitious material, the artificial rock material 106 may contain fibers that bond with the cementitious material for increased strength. Many different types of fibrous materials are contemplated by the invention. In addition, the artificial rock material 106 may contain coloring agents so that the molded artificial rock more closely simulates the appearance of a natural rock.

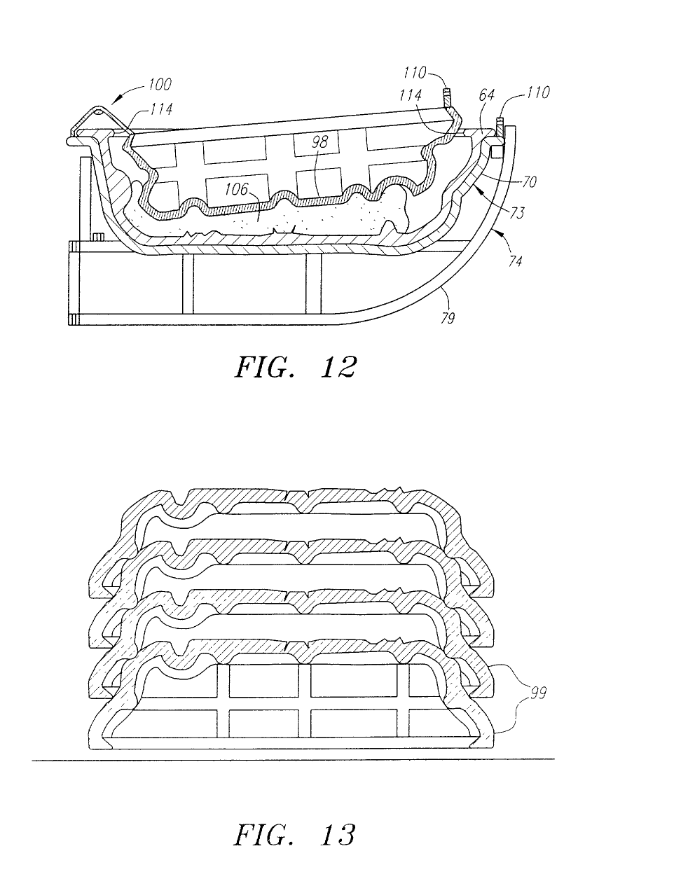

After artificial rock material 106 is added to outer mold 73, the inner shell 98 is then rotated down into the outer mold 73 spreading the cementitious material in the cavity formed between the inner shell 98 and outer mold 73, as shown in FIG. 12. The support stand 74 is then vibrated by a pneumatic vibrator settling the artificial rock material 106, erasing any voids and densifying the artificial rock material 106. While the support stand 74 is being vibrated, the inner shell 98 is continuously lowered into the outer mold 73 spreading the artificial rock material 106 out between the inner shell 98 and the outer mold 73. The inner shell 98 is lowered until the artificial rock material 106 fills in all of the crevices formed in the malleable mold 64 and fills the entire cavity between the inner shell 98 and the outer mold 73. The artificial rock material 106 thus fills the same area as the water does as shown in FIG. 10. After the outer shell 98 is rotated fully down into the inner shell, and the pneumatic vibrator has run for a sufficient amount of time, the pneumatic vibrator is turned off allowing the cementitious material time to harden. During this phase, excess cementitious material may spill from the cavity between the inner shell 98 and outer mold 73.

After the cementitious material has hardened sufficiently, the outer shell 98 is rotated out and away from the molded artificial rock 99 and the support stand 74 is rotated over on the rocker arm 79 turning the support stand 74 completely over. The support stand is then rotated back to its original position dislodging the artificial rock.

The resulting artificial rock is a production artificial rock 99 that possesses the desired strength and weight. The mold, which is comprised of the inner shell 98 and the outer mold 73 and preferably the support stand, is now ready to make additional production artificial rocks of the same design.

Artificial rocks 99 made from this final mold, may be used to create more molds of the same rock. Preferably the first artificial rock 99 made from the final mold is used for this purpose, as this will be when the rock features included on surface 66 of malleable mold 64 will be the sharpest. Prior to creating the additional molds of the artificial rock 99, however, the square edges of the artificial rock 99 are preferably ground down so that they have a radius edge. The artificial rock 99, now with the radius edges, is coated with the release agent 62. Once the release agent 62 dries, a malleable molding material is applied to the exposed surfaces of the artificial rock over the release agent 62 to form a second malleable mold 64. The malleable molding material used to form malleable mold 64 is preferably a latex rubber material as before. The new malleable mold 64 of the artificial rock will now have a turned down edge 114, as shown in FIGS. 9-12. Subsequently, all artificial rocks cast from this new malleable mold 64 will have radius edges, which helps to prevent the edge of the artificial rock from chipping or breaking during transport. The process for forming the outer shell and inner shell for the new mold is the same as described for the mold from the natural rock 50. Any number of molds can be made from this artificial rock with the radius edges, however, the preferred number of molds with the turned down edge is ten. The original mold, without a turned down edge as shown in FIG. 8, may also be used for the production of the artificial rocks 99. However, because the mold does not have the turned down edge, the square edges of the artificial rocks 99 produced from this mold are preferably ground down so that they have a radius edge.

After molding, the artificial rocks 99 may be stained or painted natural colors to simulate natural rocks. In addition, the cementitious material 106 used to make the artificial rocks 99 can initially be colored prior to the casting of the rock, such that the color is integral to the cementitious material. The colored cementitious material can then also be painted or stained so that the artificial rock looks like a natural rock.

FIG. 13 shows a set of completed artificial rocks 99, all of the same design as shown in FIG. 8, stacked and ready for transportation. The weight of each artificial rock 99 presses down on all of the artificial rocks below it in the stack. The weight of the artificial rock 99 and the artificial rocks 99 stacked above it, force open the lip 87 of each artificial rock 99 in the hoop direction. This deflection in the hoop direction allows the artificial rock 99 below it in the stack to be inserted deeper and deeper into the open cavity of the artificial rock 99 above it in the stack. This constant wedging of the artificial rocks causes conventional artificial rocks to crack and to become stuck together by their own weight and the vibration associated with transportation. The extra cementitious material forming reinforcing ring 87, however, resists the hoop deflection and reduces cracking of the artificial rock and the tendency of stacked artificial rocks to become wedged together during transportation.

Although the invention has been described and illustrated in the above description and drawings, it is understood that this description is by example only and that numerous changes and modifications can be made by those skilled in the art without departing from the scope of the invention. The invention, therefore, is not to be restricted, except by the following claims and their equivalents.

What is claimed:

1. A method of manufacturing an artificial rock, comprising the steps of:
(a) making an outer negative mold of a portion of a surface of natural rock;
(b) forming a test artificial rock with a cementitious material using the outer negative mold, the test artificial rock comprising an outer surface that replicates the portion of the surface of the natural rock and an inner surface defining a cavity;
(c) adding reinforcing members to the inner surface of the test artificial rock;
(d) making an inner mold of the inner surface of the test artificial rock;
(e) forming an artificial rock from a liquid cementitious material by molding the liquid cementitious material between the outer mold and the inner mold.

2. The method of claim 1, wherein the reinforcing members comprise ribs.

3. The method of claim 1 further comprising the steps of:
(f) grinding square edges on the artificial rock to a radius edge;
(g) making a second outer mold of the exterior surface of the artificial rock with the radius edges and a second inner mold of the interior surface of the artificial rock with the radius edges;
(h) forming a molded artificial rock with radius edges from liquid cementitious material by molding the liquid cementitious material between the second outer mold and the second inner mold.

4. The method of claim 1 wherein the outer mold comprises a malleable mold and a semi-rigid outer shell, the malleable mold having an inner surface that contains negative impressions corresponding to the surface features of the natural rock being replicated and an outer surface which mates with a corresponding inner surface of the semi-rigid outer shell.

5. The method of claim 4, wherein the semi-rigid outer shell comprises fiberglass.

6. The method of claim 4, wherein the malleable mold comprises latex rubber.

7. The method of claim 1, further comprising making a plurality of test artificial rocks with cementitious material using the outer mold, and compression testing at least one of the plurality of test artificial rocks for structural strength to identify structurally weak areas in the test artificial rocks.

8. The method of claim 7, wherein the reinforcing members are added to one of the test artificial rocks at the identified structurally weak areas and the inner mold is made from this test artificial rock.

9. The method of claim 1, wherein the reinforcing members comprise cementitious material.

10. The method of claim 1, further comprising grinding square edges on the artificial rock to a radius edge.

11. The method of claim 1, further comprising connecting the inner mold to the outer mold by a hinge.

12. The method of claim 1, further comprising vibrating the first mold and the second mold while molding the liquid cementitious material between the outer and inner molds.

13. The method of claim 1, further comprising painting or staining the surface of the formed artificial rock.

14. The method of claim 1, wherein the liquid cementitious material is colored to simulate a natural rock color.

15. The method of claim 14, further comprising painting or staining the surface of the formed artificial rock.

16. The method of claim 3, further comprising painting or staining the surface of the formed artificial rock with radius edges.

17. The method of claim 3, wherein the liquid cementitious material used to form the artificial rock with radius edges is colored to simulate a natural rock color.

18. The method of claim 16, further comprising painting or staining the surface of the formed artificial rock with radius edges.

19. The method of claim 1, further comprising coating the portion of the surface of the natural rock with a release agent prior to making the outer mold.

20. The method of claim 1, further comprising coating the opposing surfaces of the outer and the inner mold with a release agent prior to forming the artificial rock from the liquid cementitious material.

21. The method of claim 1, further comprising the step of predetermining the volume of the liquid cementitious material to use to form the artificial rock.

22. The method of claim 21, wherein the volume of liquid cementitious material to use to form the artificial rock is determined by adding an amount of water to the outer mold that exceeds the volume of space between the outer and inner molds when in their respective positions for molding the artificial rock, placing the outer and inner molds in their respective positions for molding the artificial rock to expel excess water from the outer mold, and measuring the volume of water remaining in the outer mold.

23. The method of claim 22 wherein the volume of the liquid cementitious material is approximately 102% of the water volume remaining in the outer mold.

24. A method according to claim 1, wherein the inner mold comprises a semi-rigid shell.

25. A method according to claim 24, wherein the semi-rigid shell comprises fiberglass.

26. A method of manufacturing an artificial rock, comprising the steps of:
(a) coating a portion of the surface of a natural rock with a release agent;
(b) making an outer negative mold of the portion of the surface of the natural rock, the outer negative mold comprising a malleable mold and a fiberglass shell, the malleable mold having an inner surface that contains negative impressions corresponding to the surface features of the natural rock being replicated and an outer surface which mates with a corresponding inner surface of the fiberglass shell;
(c) forming a test artificial rock with a cementitious material using the outer negative mold, the test artificial rock comprising an outer surface that replicates the portion of the surface of the natural rock and an inner surface defining a cavity;
(d) adding reinforcing ribs to the inner surface of the test artificial rock, the reinforcing ribs comprising cementitious material;
(e) making an inner mold comprising a fiberglass shell of the inner surface of the test artificial rock;
(f) forming an artificial rock from a liquid cementitious material by molding the liquid cementitious material between the outer mold and the inner mold.

27. The method of claim 26, further comprising the steps of:
(g) grinding square edges on the artificial rock to a radius edge;
(h) making a second outer mold of the exterior surface of the artificial rock with the radius edges and a second inner mold of the interior surface of the artificial rock with the radius edges;
(i) forming a molded artificial rock with radius edges from liquid cementitious material by molding the liquid cementitious material between the second outer mold and the second inner mold.

28. The method of claim 26, further comprising making a plurality of test artificial rocks with cementitious material using the outer mold, and compression testing at least on of the plurality of test artificial rocks for structural strength to identify structurally weak areas in the test artificial rocks.

29. The method of claim 28, wherein the reinforcing ribs are added to one of the test artificial rocks at the identified structurally weak areas and the inner mold is made from this test artificial rock.

30. The method of claim 26, further comprising grinding square edges on the artificial rock to a radius edge.

31. The method of claim 26, wherein the malleable mold comprises latex rubber.

32. The method of claim 26, further comprising painting or staining the surface of the formed artificial rock.

33. The method of claim 26, wherein the liquid cementitious material is colored to simulate a natural rock.

34. The method of claim 33, further comprising painting or staining the surface of the formed artificial rock.

35. The method of claim 27, further comprising painting or staining the surface of the formed artificial rock with radius edges.

36. The method of claim 27, wherein the liquid cementitious material used to form the artificial rock with radius edges is colored to simulate a natural rock color.

37. The method of claim 36, further comprising painting or staining the surface of the formed artificial rock with radius edges.

38. An artificial rock comprising:
a dome of hardened cementitious material having a generally concave interior surface and an exterior surface that replicates the surface features of a natural rock;
a reinforcing ring around the edge of the inner circumference of the dome; and
reinforcing ribs along the interior surface of the dome.

39. The artificial rock of claim 38 wherein the reinforcing ring is comprised of hardened cementitious material.

40. The artificial rock of claim 39 wherein the reinforcing ring at least doubles the thickness of the dome wall at the inner circumference of the dome.

41. The artificial rock of claim 39 wherein the reinforcing ring at least triples the thickness of the dome wall at the inner circumference of the dome.

42. The artificial rock of claim 38 wherein the ribs are comprised of hardened cementitious material.

43. The artificial rock of claim 38 wherein the exterior surface of the dome is painted to simulate a natural rock.

44. The artificial rock of claim 38 wherein the exterior surface of the dome is stained to simulate a natural rock.

45. The artificial rock of claim 38 wherein the cementitious material is colored to simulate a natural rock.

46. The artificial rock of claim 38 wherein the cementitious material is colored and the exterior surface is stained to simulate a natural rock.

47. A support stand suitable for forming artificial rocks, comprising:
a plurality of straight members connected horizontally and vertically to form a frame to support a rock mold;
a rocker arm connected to the frame at one end, the rocker arm curving vertically to support the rock mold at one end; and
a rocker pivot point that is between the rock mold's center of gravity and the rocker arm.

48. A support stand suitable for forming artificial rocks of claim 47, wherein the straight members and rocker arm are made from aluminum

49. A support stand suitable for forming artificial rocks of claim 47, wherein the straight members and rocker arm are made from steel.

50. A support stand suitable for forming artificial rocks of claim 47, wherein the straight members and rocker arm welded together.

51. A support stand suitable for forming artificial rocks of claim 47, wherein the straight members and rocker arm comprise a weldable metal.

52. A support stand suitable for forming artificial rocks of claim 47, wherein the straight members and rocker arm comprise tubes of weldable metal.
